(19) United States
(12) Patent Application Publication
(10) Pub. No.: US 2006/0121778 A1
(43) Pub. Date: Jun. 8, 2006

(54) Jumper device and jumper assembly

(75) Inventor: Jen-Yuan Huang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/269,686

(22) Filed: Nov. 9, 2005

(30) Foreign Application Priority Data
Dec. 3, 2004 (TW) 093137519

(51) Int. Cl. H01R 31/08

(52) U.S. Cl. 439/507

(57) ABSTRACT

A jumper device includes a jumper and a connecting member. In this case, one end of the connecting member connects with the jumper device. Another end of the connecting member has at least one connecting portion. A jumper assembly including the jumper device is also provided.

### BACKGROUND OF THE INVENTION

1. Field of Invention

The invention relates to a jumper device, and more particularly to a jumper device used in an electrical device.

2. Related Art

A jumper is a tool for changing the circuit. In a computer, for example, a mainboard often has to fit with various electrical elements with different specifications, such as CPUs (Central Processing Units) with different speeds or different output voltages. If the manufacturer manufactures many kinds of mainboards to meet various conditions, the cost efficiency is low. It is possible to modify one trace on the mainboard to meet two different CPUs. In such a case, the jumper may be used in a simple way by only pulling up the jumper from the pin header of the mainboard, changing the position of the jumper, and then inserting the jumper into another position of the pin header. Consequently, the clock of the processor may be set, or the hard disk can be modified from a master to a slave. Hence, the provision of the jumper can increase the support of the circuit board with various electrical elements and the apparatuses thereof.

Another application of the jumper on the mainboard is to clear the settings of the CMOS (Complementary Metal-Oxide Semiconductor). In this case, the positions of most of the jumpers and pin headers are located near the battery. Accordingly, the BIOS (Basic Input Output System) can be reset to the default value.

FIG. 1 is a schematic illustration showing a conventional jumper 10. The jumper 10 is inserted onto a pin header 21 of a mainboard 20. The pin header 21 has a plurality of pins 22. A casing 11 of the jumper 10 is made of an insulation plastic material, and a conductive jumper metal 12 is disposed in the casing 11. When the jumper 10 is inserted onto the pin header 21, the conductive jumper metal 12 of the jumper 10 contacts two pins 22 of the pin header 21 such that the two pins 22 are connected to each other to form a close circuit (ON state). Therefore, a current may flow between the two pins 22. On the contrary, when the jumper 10 is not inserted onto the pin header 21, the two pins 22 are in an open circuit (OFF state).

In general, the jumper 10 is placed in a kit package for the mainboard 20 as the consumer purchases the mainboard 20, such that the user can determine whether or not the jumper 10 has to be disposed onto the pin header 21 of the mainboard 20.

However, once the jumper 10 is removed from the mainboard 20, the jumper 10 tends to be lost and cannot be easily found because the size of the jumper 10 is very small. Consequently, the user has to send the mainboard 20 back to the original manufacturer if the mainboard 20 cannot work due to the lost jumper 10. The mainboard 20 cannot normally work until the manufacturer inserts a new jumper 10 on the mainboard 20. As a result, a small jumper 10 brings inconvenience for the user and the manufacturer if it is lost. The manufacture has to spend a lot of costs, which include the transportation, manpower and material costs and are much higher than that of the jumper 10, so as to solve the problem caused by the lost jumper 10.

It is therefore an important subject of the invention to provide a -jumper device and a jumper assembly to solve the above-mentioned problem.

### SUMMARY OF THE INVENTION

In view of the foregoing, the invention is to provide a jumper device, which includes a connecting member capable of preventing the jumper device from being lost, and a jumper assembly.

To achieve the above, a jumper device of the invention includes a jumper and a connecting member. In the invention, the connecting member includes one end connected with the jumper and the other end configured with at least one connecting portion.

To achieve the above, the invention also provides a jumper assembly disposed on a circuit board. The jumper assembly includes a jumper, a connecting member and a pin header. The connecting member includes one end connected with the jumper and the other end configured with at least one connecting portion. The pin header is disposed on the circuit board. The connecting portion is connected with the pin header.

As mentioned above, each of the jumper device and the jumper assembly of the invention has a connecting member to prevent the jumper device from being lost. Compared to the prior art, the jumper device and the jumper assembly of the invention utilize a connecting member having a connecting portion to fix the jumper at a predetermined position. Consequently, when the jumper of the invention is not in use, it still can be fixed at the predetermined position. Therefore, the user does not have to worry about the loss of the jumper device, and the problem of incapable of starting the computer or even the damage of the mainboard owing to the loss of the jumper device can be eliminated. Furthermore, when the user wants to use the jumper device at the next time, he/she can easily find the jumper device because the jumper device is fixed at the predetermined position. In addition, the mainboard manufacturer can provide the jumper device having the connecting member and the assembly of the jumper device so as to decrease the number of mainboards to be sent back to the original manufacturer due to the loss of the jumper, and thus decrease the transportation, manpower and material costs for maintenance.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing the conventional jumper device;

FIG. 2 is a schematic illustration showing a jumper device according to a preferred embodiment of the invention;

FIG. 3 is a schematic illustration showing another jumper device according to the preferred embodiment of the invention;

FIG. 4 is a schematic illustration showing a jumper assembly according to the preferred embodiment of the invention;

FIG. 5 is a schematic illustration showing another jumper assembly according to the preferred embodiment of the invention; and

FIG. 6 is a schematic illustration showing still another jumper assembly according to the preferred embodiment of the invention.

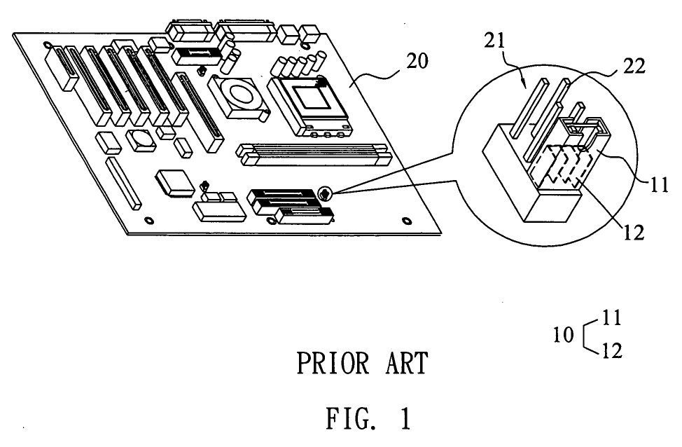

### DETAILED DESCRIPTION OF THE INVENTION

The present invention will be apparent from the following detailed description, which proceeds with reference to the accompanying drawings, wherein the same references relate to the same elements.

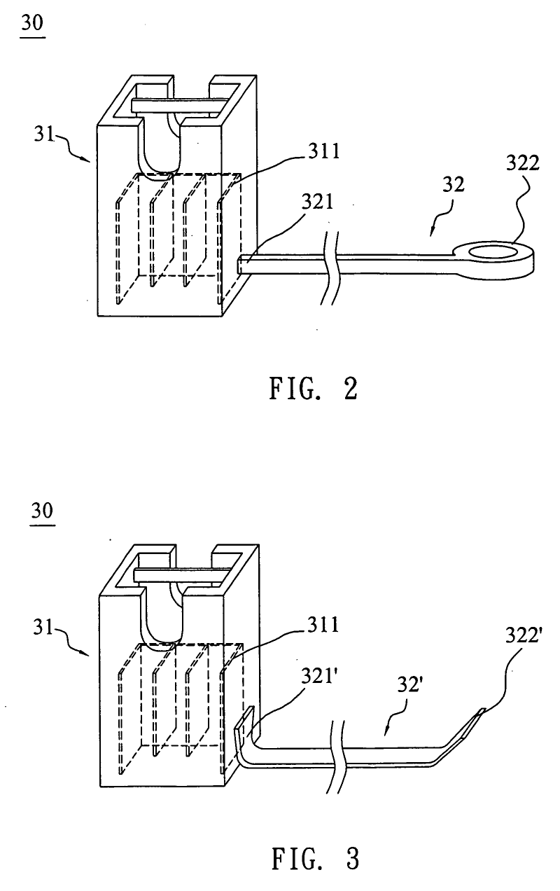

First, jumper devices according to a preferred embodiment of the invention will be described with reference to FIGS. 2 and 3.

FIG. 2 is a schematic illustration showing a jumper device according to the embodiment of the invention. The jumper device 30 includes a jumper 31 and a connecting member 32.

The casing of the jumper 31 is made of an insulation material such as a plastic material. The jumper 31 has a conductive jumper metal 311 inside the casing. When the jumper 31 is used, the jumper 31 is inserted by a pin header. At this time, the conductive jumper metal 311 of the jumper 31 can contact two pins of the pin header such that the pins are connected to each other through the conductive jumper metal 311 to form a close circuit (ON state), and the circuit of the electrical device can be changed.

With reference to FIG. 2, the connecting member 32 has one end 321 connected with the jumper 31, and another end configured with at least one connecting portion 322. In this embodiment, the connecting member 32 may be made of a non-conductive material, such as a plastic material, or a paper sheet.

The connecting member 32 may be integrally formed with the jumper 31 by way of injection molding such that the one end 321 of the connecting member 32 is connected with the jumper 31.

Another end of the connecting member 32 is configured with at least one connecting portion 322. In this embodiment, the connecting portion 322 has a through hole. The connecting member 32 can be fit into an arbitrary position on an electrical device having a projection using the through hole of the connecting portion 322, so that the jumper 31 connected with the connecting member 32 can be fixed. The predetermined position may be an arbitrary position on the mainboard or other electrical devices. For example, the connecting portion 322 may be fit onto a pin header. Consequently, when the jumper 31 is not used, the connecting portion 322 fixes the jumper 31 onto the pin header to prevent the jumper 31 from being lost. In addition, the connecting member 32 also may have a plurality of connecting portions 322 for fixing the jumper 31 in a more effective manner. Of course, the number of the connecting portion(s) 322 may be determined according to the actual requirement. In the current embodiment, one connecting portion 322 is provided.

FIG. 3 is a schematic illustration showing another jumper device according to the embodiment of the invention. In this case, the connecting member 32′ may be a sheet, which is made of a paper sheet. The one end 321′ of the connecting member 32′ is adhered to the jumper 31, and the connecting portion 322′ at the other end may have an adhesive layer for fixing the jumper 31 at a predetermined position, which may be an arbitrary position on the mainboard or any electrical device. For example, the connecting portion 322′ may be adhered to a pin header. Consequently, when the jumper 31 is not used, the connecting portion 322′ can fix the jumper 31 to prevent the jumper 31 from being lost.

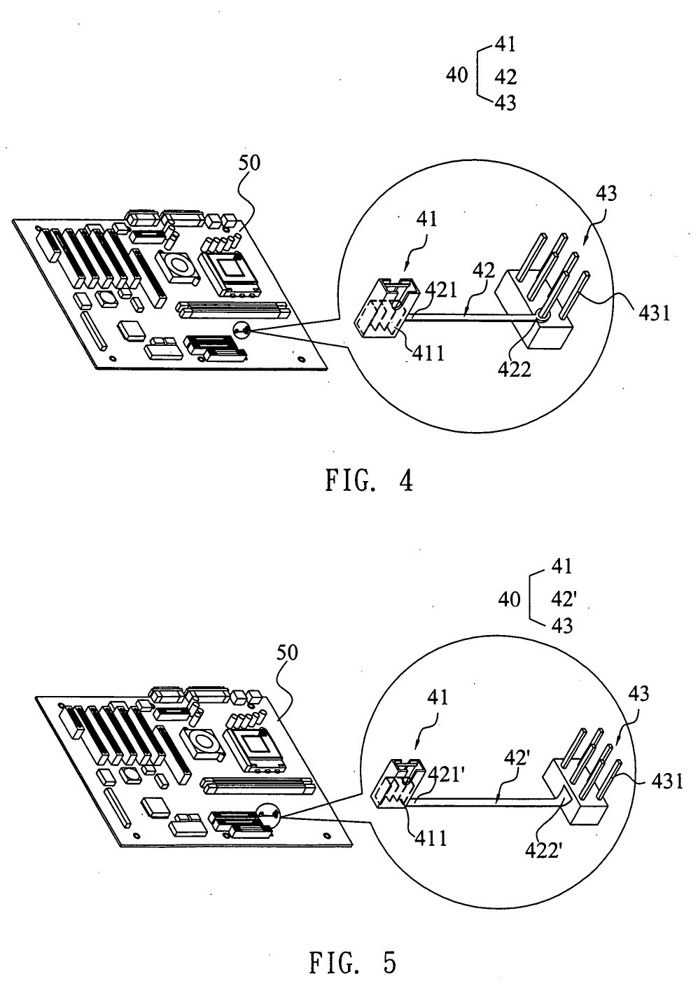

Next, the jumper assemblies according to the preferred embodiment of the invention will be described with reference to FIGS. 4 and 5.

FIG. 4 is a schematic illustration showing a jumper assembly 40 according to the preferred embodiment of the invention. The jumper assembly 40, which is disposed on a circuit board 50, includes a jumper 41, a connecting member 42 and a pin header 43.

The casing of the jumper 41 is made of an insulation material such as a plastic material. The jumper 41 has a conductive jumper metal 411 disposed inside the casing. The pin header 43 may further have a plurality of pins 431. When the jumper assembly is being used, the jumper 41 can be fit onto the pins 431 of the pin header 43. The conductive jumper metal 411 of the jumper 41 connects two pins 431 of the pin header 43 to form a close circuit (ON state) so as to change the circuit of the electrical element on the circuit board 50.

As shown in FIG. 4, one end 421 of the connecting member 42 is connected with the jumper 41, and another end of the connecting member 42 is configured with at least one connecting portion 422. In this embodiment, the connecting member 42 may be made of a non-conductive material, such as a plastic material or a paper sheet. The connecting member 42 may be integrally formed with the jumper 41 such that the one end 421 of the connecting member 42 is connected with the jumper 41.

Another end of the connecting member 42 is configured with at least one connecting portion 422. In this embodiment, the connecting portion 422 has a through hole. The connecting member 42 may be fit at an arbitrary position having a projection using the through hole, so that the jumper 41 connected with the connecting member 42 can be fixed. In this embodiment, the connecting member 42 may be fit onto the pin header 43 of the circuit board 50 using the through hole of the connecting portion 422. Consequently, when the jumper 41 is not used (i.e., when the jumper 41 is not fit onto the pin header 43), the connecting portion 422 may be used to fix the jumper 41 to the pin header 43. Thus, it is possible to prevent the jumper 41 from being lost and the jumper 41 can be easily found when it has to be used.

In addition, the connecting member 42 also may have a plurality of connecting portions 422 for fixing the jumper 41 in a more effective manner. Of course, the number of the connecting portion(s) 422 may be determined according to the actual requirement. In this embodiment, one connecting portion 422 is used.

FIG. 5 is a schematic illustration showing another jumper assembly according to the embodiment of the invention, wherein the connecting member 42′ may be made of a paper sheet. The one end 421′ of the connecting member 42′ is adhered to the jumper 41, and the connecting portion 422′ configured at another end of the connecting member 42′ may have an adhesive layer for fixing the jumper 41 at the pin header 43 of the circuit board 50.

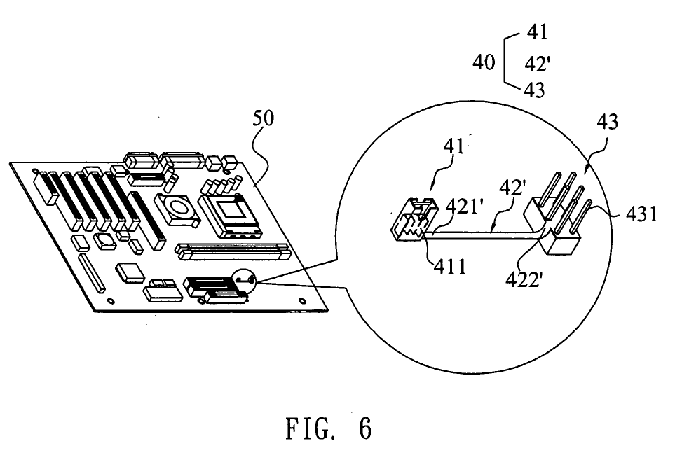

FIG. 6 is a schematic illustration showing still another jumper assembly according to the preferred embodiment of the invention, wherein the connecting portion 422′ may be a sticker having a plurality of holes. The pins 431 can pass through the connecting portion 422′, which is adhered to the pin header 43 with a larger adhering area to enhance the force for fixing the jumper 41. Consequently, when the jumper 41 is not used (i.e., when the jumper 41 is not fit onto the pin header 43), the connecting portion 422′ may be used to fix the jumper 41 around the pin header 43. Thus, it is possible to prevent the jumper 41 from being lost and the jumper 41 can be easily found when it has to be used.

In summary, each of the jumper devices and the jumper assemblies of the invention have a connecting member to prevent the jumper device from being lost. Compared to the prior art, the jumper device and the jumper assembly of the invention utilize the connecting member having a connecting portion to fix the jumper at a predetermined position. Consequently, when the jumper is not used, it still can be fixed at the predetermined position. Thus, the user does not have to worry about the loss of the jumper device, and the problem of incapable of starting the computer or even the damage of the mainboard owing to the loss of the jumper device can be eliminated. Furthermore, when the user wants to use the jumper device at the next time, he/she can easily find the jumper device because the jumper device is fixed at the predetermined position. In addition, the mainboard manufacturer can provide the jumper device having the connecting member and the assembly of the jumper device so as to decrease the number of mainboards to be sent back to the original manufacturer due to the loss of the jumper, and thus decrease the transportation, manpower and material costs for maintenance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A jumper device, comprising:
a jumper; and
a connecting member having one end connected with the jumper and another end configured with at least one connecting portion.

2. The jumper device according to claim 1, wherein the connecting member is made of a non-conductive material.

3. The jumper device according to claim 1, wherein the connecting member is made of a plastic material.

4. The jumper device according to claim 1, wherein the connecting member and the jumper are integrally formed.

5. The jumper device according to claim 1, wherein the one end of the connecting member is adhered to the jumper.

6. The jumper device according to claim 1, wherein the connecting portion has a through hole.

7. The jumper device according to claim 1, wherein the connecting member is made of a paper sheet.

8. The jumper device according to claim 1, wherein the connecting portion has an adhesive layer.

9. A jumper assembly disposed on a circuit board, comprising:
a jumper;
a connecting member having one end connected with the jumper and another end configured with at least one connecting portion; and
a pin header disposed on the circuit board and connected with the connecting portion.

10. The jumper assembly according to claim 9, wherein the connecting member is made of a non-conductive material.

11. The jumper assembly according to claim 9, wherein the connecting member is made of a plastic material.

12. The jumper assembly according to claim 9, wherein the connecting member and the jumper are integrally formed.

13. The jumper assembly according to claim 9, wherein the connecting portion has a through hole, and the pin header is fit into the through hole.

14. The jumper assembly according to claim 9, wherein the connecting member is made of a paper sheet.

15. The jumper assembly according to claim 9, wherein the connecting portion has an adhesive layer.

16. The jumper assembly according to claim 9, wherein the one end of the connecting member is adhered to the jumper.

17. The jumper assembly according to claim 9, wherein the connecting portion is adhered to the pin header.
